(19) United States
(12) Patent Application Publication
(10) Pub. No.: US 2026/0161124 A1
(43) Pub. Date: Jun. 11, 2026

(54) CONTROL DEVICE, IMAGE FORMING APPARATUS, AND STORAGE MEDIUM

(71) Applicant: Konica Minolta, Inc., Tokyo (JP)

(72) Inventor: Takefumi NISHIO, Tokyo (JP)

(21) Appl. No.: 19/409,907

(22) Filed: Dec. 5, 2025

(30) Foreign Application Priority Data
Dec. 5, 2024 (JP) 2024-212146

(51) Int. Cl. G03G 15/00; G01B 11/27; G03G 15/01; G06K 15/02; G06T 7/00

(52) U.S. Cl. CPC G03G 15/5062; G01B 11/272; G03G 15/0131; G03G 15/0189; G03G 15/5029; G03G 15/6564; G03G 15/6594; G06K 15/027; G06T 7/0004; G03G 2215/00481; G03G 2215/00599; G06T 2207/10008; G06T 2207/10024; G06T 2207/30144

(57) ABSTRACT

A control device includes a hardware processor that: measures, in an image formed on a sheet, an amount of a color misregistration in a conveyance direction of the sheet; determines, based on the measured amount of the color misregistration at a predetermined position in the conveyance direction, a correction value for correcting the color misregistration in the conveyance direction; and corrects the color misregistration in an image to be formed on the sheet by using the determined correction value.

### CROSS REFERENCE TO RELATED APPLICATIONS

The present invention claims priority under 35 U.S.C. § 119 to Japanese Patent Application No. 2024-212146 filed on Dec. 5, 2024, the entire content of which is incorporated herein by reference.

### BACKGROUND OF THE INVENTION

### Technical Field

The present disclosure relates to a control device, an image forming apparatus, and a storage medium.

### Description of Related Art

The need for thick paper is increasing in various sectors within the production printing market. Consequently, in recent years, with increase of the need, color misregistration in a sheet feeding direction has become a prominent issue in printing by the electrophotographic method using intermediate transfer, as thick paper is easily affected by the color misregistration.

In this connection, Japanese Unexamined Patent Application Publication No. 2022-071703 discloses an image forming apparatus that reads a test chart formed on a sheet and controls the speed of a roller at a transfer portion based on the read data to correct the partial magnification of an image to be formed on the sheet.

### SUMMARY OF THE INVENTION

However, the color misregistration correction in the conventional invention does not consider the fact that the color misregistration amount changes depending on the position in the sheet feeding direction within the sheet, and there is a possibility that the color misregistration correction becomes insufficient.

An object of the present disclosure is to provide a control device, an image forming apparatus, and a storage medium that can accurately correct color misregistration in an image formed on a sheet.

To achieve at least one of the abovementioned objects, a control device reflecting one aspect of the present invention comprises: a hardware processor that: measures, in an image formed on a sheet, an amount of a color misregistration in a conveyance direction of the sheet; determines, based on the measured amount of the color misregistration at a predetermined position in the conveyance direction, a correction value for correcting the color misregistration in the conveyance direction; and corrects the color misregistration in an image to be formed on the sheet by using the determined correction value.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a front view illustrating a schematic configuration of an image forming apparatus according to an embodiment;

FIG. 2 is a functional block diagram illustrating a control structure of the image forming apparatus according to the embodiment;

FIG. 3 is a diagram illustrating a case where a sheet conveyance speed at a fixing section is higher than a sheet conveyance speed at a transfer portion;

FIG. 4 is a diagram illustrating a case where the sheet conveyance speed at the fixing section is lower than the sheet conveyance speed at the transfer portion;

FIG. 5 is a flowchart illustrating a flow of color misregistration correction processing;

FIG. 6 is a diagram illustrating a color misregistration amount between black and cyan;

FIG. 7 is a diagram illustrating a color misregistration amount between black and magenta; and

FIG. 8 is a diagram illustrating a color misregistration amount between black and yellow.

### DETAILED DESCRIPTION

Hereinafter, one or more embodiments of the present invention will be described with reference to the drawings. However, the scope of the invention is not limited to the disclosed embodiments.

### 1. Configuration of Image Forming Apparatus

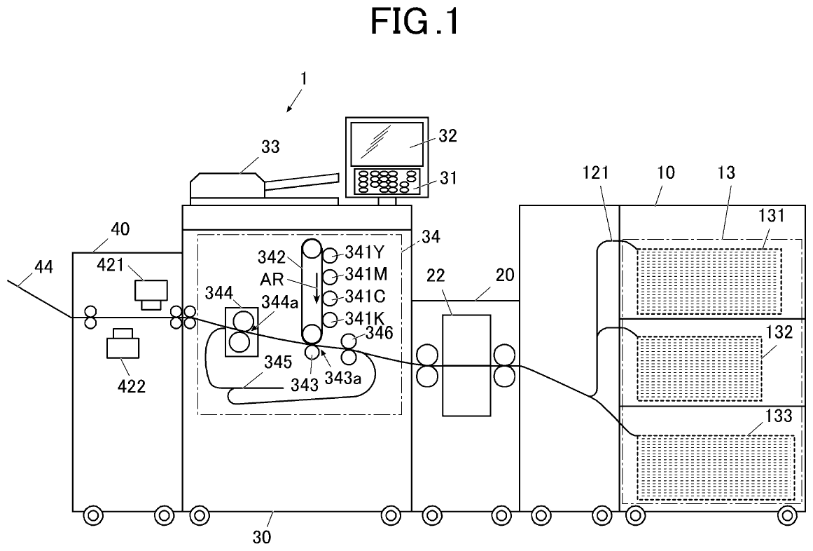

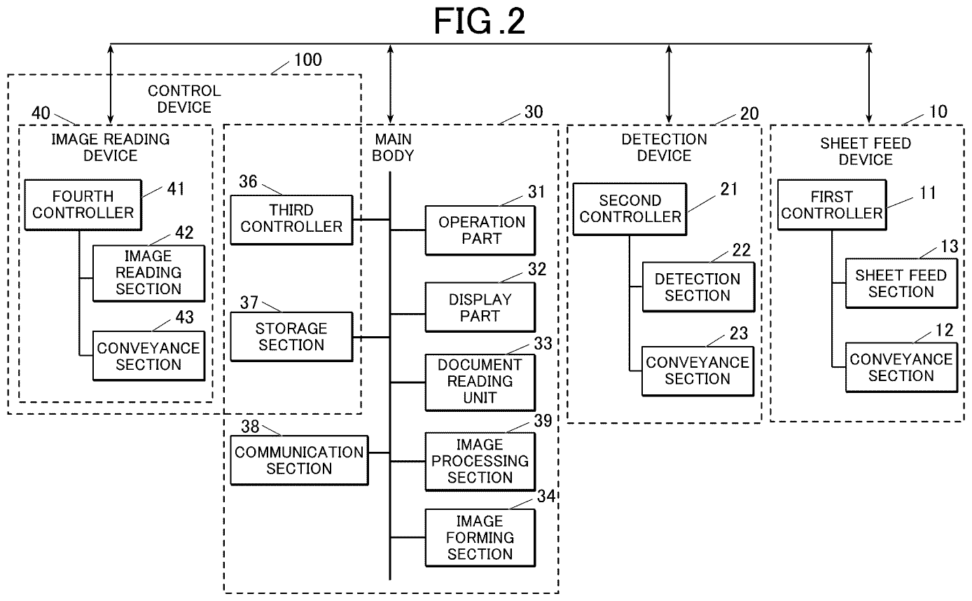

As shown in FIG. 1 and FIG. 2, an image forming apparatus 1 according to the present embodiment includes a sheet feed device 10, a detection device 20, a main body 30, and an image reading device 40.

In the image forming apparatus 1, the sheet feed device 10, the detection device 20, the main body 30, and the image reading device 40 are arranged in this order from upstream in the sheet conveyance direction.

### 1-1. Configuration of Sheet Feed Device

The sheet feed device 10 includes a first controller (hardware processor) 11, a conveyance section 12, and a sheet feed section 13.

The first controller 11 includes a central processing unit (CPU), a read only memory (ROM), a random-access memory (RAM), and the like.

The CPU of the first controller 11 reads a program stored in the ROM, develops the program in the RAM, and integrally controls each unit of the sheet feed device 10 according to the developed program.

For example, the controller 11 conveys a sheet from any of sheet feed trays 131 to 133 of the sheet feed section 13 to the detection device 20 in accordance with a print job.

The conveyance section 12 includes a conveyance route 121 connecting the sheet feed section 13 to the detection device 20 and conveys a sheet.

The sheet feed section 13 includes the sheet feed trays 131 to 133 that store sheets by predetermined paper type, size, and the like. For example, the sheet feed tray 131 stores sheets having a larger size than the sheets stored in the sheet feed tray 132. The sheet feed tray 133 stores sheets having a greater sheet thickness than the sheets stored in the sheet feed trays 131 and 132.

### 1-2. Configuration of Detection Device

The detection device 20 is located downstream of the sheet feed device 10 in the sheet conveyance direction and upstream of the main body 30 in the sheet conveyance direction.

The detection device 20 detects a physical property of the sheet conveyed from the sheet feed device 10 and outputs a physical property value, which is an obtained detection result, to a third controller (hardware processor) 36 which will be described later. The physical property value of the sheet is attribute information of the sheet.

The detection device 20 detects values (physical property values) relating to physical properties of a plurality of types of sheets including basis weight, stiffness, moisture content, surface properties, and the like of the sheets. The physical property value may be information that can be converted (transformed) into a physical property.

The detection device 20 includes a second controller (hardware processor) 21, a detection section (detector) 22, and a conveyance section 23.

The second controller 21 includes a CPU, a ROM, and a RAM.

The CPU of the second controller 21 reads a program stored in the ROM, develops the program in the RAM, and integrally controls each unit of the detection device 20 according to the developed program.

For example, the second controller 21 causes the detection section 22 to detect the sheet conveyed from the sheet feed device 10 and outputs the obtained physical property value to the third controller 36. Next, the second controller 21 causes the conveyance section 23 to convey the detected sheet to the main body 30.

The detection section 22 detects a physical property value in a sheet.

The detection section 22 includes sensors that detect the basis weight, stiffness, moisture content, surface properties, and the like of a sheet as physical property values of the sheet.

For example, a sensor that detects the basis weight of a sheet includes a light emitting section and a light receiving section and measures the basis weight based on the amount of attenuation of light transmitted through the sheet. The detection section 22 outputs the basis weight as a physical property value to the second controller 21.

The sensor that performs detection of the stiffness of a sheet detects a physical property corresponding to the stiffness of the sheet. For example, when a sheet is conveyed in a curved conveyance path, the sensor mechanically measures the force applied by the sheet onto one of the outer guide plates constituting the conveyance path in the curved conveyance path or the amount of displacement of the outer guide plate. The detection section 22 outputs, to the second controller 21, the stiffness as a physical property value based on the force applied by the sheet or the amount of displacement.

The sensor that performs detection of the moisture content of a sheet optically detects, for example, a light absorption amount of an OH group of a near-infrared method. The sensor irradiates a sheet with light having a predetermined wavelength in the near-infrared region and detects the light absorption amount using a property in which the absorptance of light changes in accordance with the moisture content of the sheet. As another example, the sensor may measure the moisture content by measuring a change in the amount of light reflected from inside the sheet using reflected light separated by a polarizing filter. The detection section 22 outputs the moisture content as a physical property value to the second controller 21.

A sensor that detects the surface properties (evenness, smoothness) of a sheet includes, for example, a reflection sensor that outputs the intensities and/or the intensity ratio of specular reflection light and scattered reflection light of the light emitted to the sheet. The sensor measures the surface properties based on the intensity ratio. The detection section 22 outputs the surface properties as a physical property value to the second controller 21.

The detection section 22 may include, in addition to the above-described sensor, a sensor that detects the specific gravity, the conductivity, and the like of the sheet.

The conveyance section 23 includes a plurality of roller pairs and conveys the sheet conveyed from the sheet feed device 10 to the detection section 22.

Next, the conveyance section 23 conveys the sheet detected by the detection section 22 to the main body 30.

### 1-3. Configuration of Main Body Section

The main body 30 is located downstream of the detection device 20 in the sheet conveyance direction and upstream of the image reading device 40 in the sheet conveyance direction.

The main body 30 forms a color image by an electrophotographic method based on image data obtained by reading an image from a document or job image data of a print job received from an external device (not shown). Next, the main body 30 conveys the sheet on which the image formation has been performed to the image reading device 40.

As shown in FIG. 1 and FIG. 2, the main body 30 includes an operation part 31, a display part 32, a document reading unit 33, an image forming section (image former) 34, a third controller 36, a storage section (storage) 37, a communication section 38, and an image processing section 39.

The operation part 31 includes a touch screen formed so as to cover a display screen of the display part 32 and various operation buttons such as numeric buttons and a start button.

The operation part 31 outputs an operation signal based on a user operation to the third controller 36.

The display part 32 includes a liquid crystal display (LCD) or the like.

The display part 32 displays various screens according to an instruction of a display signal input from the third controller 36.

The document reading unit 33 includes an automatic document feeder (ADF), a scanner, and the like.

The document reading unit 33 outputs image data obtained by reading the image of the document to the third controller 36.

The image forming section 34 forms an image by an intermediate transfer method on the sheet conveyed from the detection device 20, based on the image data subjected to image processing by the image processing section 39. In the present embodiment, the sheet is a flat cut sheet.

The image forming section 34 includes photosensitive drums 341Y, 341M, 341C, and 341K corresponding to the colors yellow (Y), magenta (M), cyan (C), and black (K), an intermediate transfer belt 342, a secondary transfer roller 343, a fixing section 344, a reverse path 345, a registration section 346, and the like.

The photosensitive drum 341Y, 341M, 341C, and 341K are arranged in series in this order along a moving direction AR of the intermediate transfer belt 342 from upstream in the moving direction AR.

The image forming section 34 uniformly charges the photosensitive drum 341Y and then scans and exposes the photosensitive drum 341Y with a laser beam based on image data of yellow color to form an electrostatic latent image. Next, the image forming section 34 develops the image by depositing yellow toner on the electrostatic latent image on the photosensitive drum 341Y.

Since the photosensitive drums 341M, 341C, and 341K are the same as the photosensitive drum 341Y except that the colors to be handled are different, the description thereof will be omitted.

The image forming section 34 sequentially transfers the toner images in the respective colors formed on the photosensitive drums 341Y, 341M, 341C, and 341K onto the rotating intermediate transfer belt 342 (primary transfer). That is, the image forming section 34 forms a color toner image in which toner images of four colors are superimposed on the intermediate transfer belt 342.

The image forming section 34 collectively transfers the color toner image on the intermediate transfer belt 342 onto the sheet by the secondary transfer roller 343 (secondary transfer). A transfer nip portion formed by the intermediate transfer belt 342 and the secondary transfer roller 343 is a transfer portion 343a.

The fixing section 344 includes a heating roller that heats the sheet on which the toner image has been transferred, and a pressure roller that presses the sheet.

The fixing section 344 sandwiches the sheet between the heating roller and the pressure roller that form a fixing nip portion 344a and fixes the color toner image on the sheet by heating and pressing.

In single-sided printing in which an image is formed on one side of a sheet in the main body 30, the third controller 36 conveys the sheet from the fixing section 344 to the image reading device 40.

On the other hand, in double-sided printing in which images are formed on both sides of a sheet, the third controller 36 conveys the sheet from the fixing section 344 to the reverse path 345 and reverses the side of the sheet. Next, the third controller 36 feeds the sheet again upstream of the registration section 346 in the sheet conveyance direction.

The registration section 346 includes a registration roller and conveys the sheet to the transfer portion 343a.

The registration section 346 corrects the inclination of the sheet conveyed from the detection device 20 and adjusts the conveyance timing of the sheet.

The third controller 36 includes a CPU, a RAM, and a ROM.

The CPU of the third controller 36 reads various programs stored in the ROM and develops them in the RAM. The third controller 36 integrally controls the operation of the main body 30 in cooperation with the various programs developed in the RAM.

The storage section 37 is a nonvolatile storage device such as a hard disk drive (HDD) or a semiconductor memory that stores various types of data such as programs and image data.

The storage section 37 stores data such as program data and various types of setting data in a manner readable and writable by the third controller 36.

The storage section 37 stores information on the sheet feed trays 131 to 133 and information on the basis weight, size, sheet type, and the like of the sheets stored in the sheet feed trays 131 to 133 in association with each other.

The communication section 38 includes a communication control card such as a local area network (LAN) card.

The communication section 38 exchanges various kinds of data with an external device (e.g., a personal computer) connected to a communication network such as a LAN or a wide area network (WAN).

The image processing section 39 performs necessary image processing on the image data stored in the storage section 37, the image data obtained by reading an image from a document by the document reading unit 33, the image data input from an external device, and the like. Next, the image processing section 39 transmits the image data after the image processing to the image forming section 34.

The image processing includes gradation processing, halftone processing, color conversion processing, and the like. The gradation processing is processing for converting the gradation value of each pixel of image data into a gradation value corrected such that the gradation of the image formed on a sheet matches the target gradation. The halftone processing is error diffusion processing, screen processing using a systematic dither method, or the like. The color conversion processing is processing for converting each gradation value of RGB into each gradation value of CMYK.

### 1-4. Configuration of Image Reading Device

The image reading device 40 is positioned downstream of the main body 30 in the sheet conveyance direction.

The image reading device 40 reads the sheet conveyed from the main body 30 and outputs data of the obtained read image to the third controller 36.

The image reading device 40 includes a fourth controller (hardware processor) 41, an image reading section 42, a conveyance section 43, and a sheet ejection tray 44.

The fourth controller 41 includes a CPU, a ROM, and a RAM.

The CPU of the fourth controller 41 reads a program stored in the ROM, develops the program in the RAM, and integrally controls each unit of the image reading device 40 according to the developed program.

For example, the fourth controller 41 causes the image reading section 42 to read a sheet conveyed from the main body 30 and outputs data of the obtained read image to the third controller 36. Next, the fourth controller 41 ejects the read sheet to the sheet ejection tray 44 by the conveyance section 43.

The image reading section 42 includes reading sections 421 and 422.

The reading section 421 reads an image on one side of the sheet and acquires read image data.

The reading section 422 reads an image on the other side of the sheet and acquires read image data.

The reading sections 421 and 422 each include a line image sensor and an illumination part.

In the line image sensor, a plurality of imaging elements (e.g., charge coupled devices (CCDs)) that photoelectrically convert incident light for each pixel is arranged in a one-dimensional array in a width direction of the sheet.

The width direction of the sheet is orthogonal to the sheet conveyance direction.

The illumination part irradiates the sheet with light in order to enable appropriate reading of the sheet. The illumination part includes, for example, an LED, a diffusion member that uniformly spreads emitted light over a reading range, and the like.

The reading sections 421 and 422 may include a contact image sensor (CIS) in which a line image sensor and an illumination part are integrated, or a two-dimensional area sensor and an illumination part, and the like.

The image reading section 42 reads either the upper surface, the lower surface, or both surfaces of the sheet conveyed from the main body 30 by the reading section 421 and/or reading section 422. Next, the image reading section 42 outputs the generated read image as a reading result to the fourth controller 41.

The image reading section 42 may include a background member serving as the background of a sheet image when the sheet is read by the image sensor or the like.

The conveyance section 43 includes a plurality of roller pairs and conveys the sheet conveyed from the main body 30 to the image reading section 42. Next, under the control of the fourth controller 41, the conveyance section 43 ejects the sheet read by the image reading section 42 to the sheet ejection tray 44.

Hereinafter, the third controller 36, the storage section 37, and the image reading device 40 are collectively referred to as a control device 100.

In the present embodiment, the third controller 36 of the main body 30 integrally controls the entire image forming apparatus 1, but the present invention is not limited thereto. The second controller 21 of the detection device 20 or the fourth controller 41 of the image reading device 40 may be configured to integrally control the entire image forming apparatus 1.

### 2. Color Misregistration Due to Speed Difference Between Fixing Speed and Transfer Speed

Next, color misregistration due to a speed difference between a sheet conveyance speed (fixing speed) in the fixing section 344 and a sheet conveyance speed (transfer speed) in the transfer portion 343a will be described.

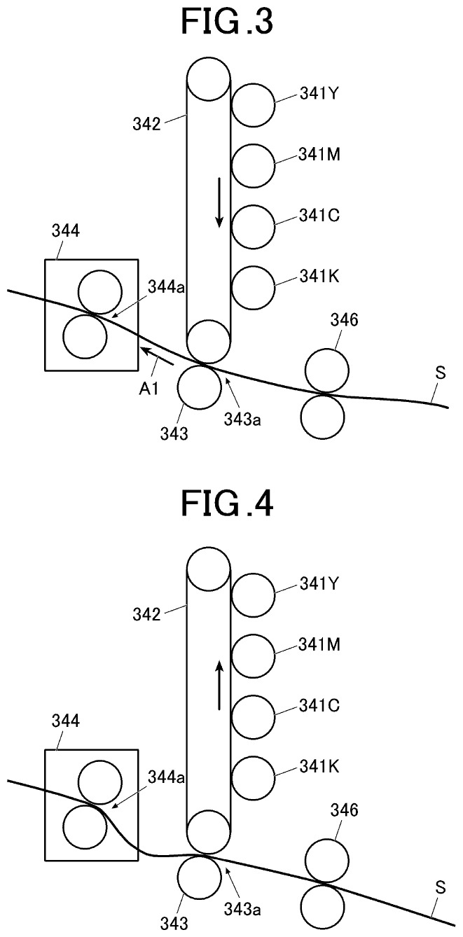

FIG. 3 illustrates a case where the fixing speed is higher than the transfer speed.

In this case, a sheet S is pulled in a direction of A1 illustrated in FIG. 3 by the fixing nip portion 344a formed by the heating roller and the pressure roller of the fixing section 344. Thus, the speed of the intermediate transfer belt 342 becomes higher than a normal value at which color misregistration does not occur, so that the primary transfer positions shift, and color misregistration occurs in an image formed on the sheet S.

FIG. 4 illustrates a case where the fixing speed is lower than the transfer speed.

In this case, the sheet S sags between the fixing section 344 and the transfer portion 343a, and the reaction force from this sagging causes the speed of the intermediate transfer belt 342 to become slower than the normal value at which color misregistration does not occur. As a result, the primary transfer positions shift, and color misregistration occurs in an image formed on the sheet S. When the sheet S is thick paper, the reaction force from the sagging is larger than that in the case of thin paper, and therefore, the speed of the intermediate transfer belt 342 tends to decrease. The thick paper is, for example, a sheet having a thickness equal to or larger than a predetermined value or a basis weight equal to or larger than a predetermined value.

The color misregistration according to the present embodiment is color misregistration between at least two colors in an image formed on a sheet.

As shown in FIG. 3 and FIG. 4, the photosensitive drums 341Y, 341M, 341C, and 341K are arranged in series along the moving direction of the intermediate transfer belt 342. Therefore, distances from the fixing nip portion 344a to the respective photosensitive drums 341Y, 341M, 341C, and 341K via the transfer portion 343a are different.

As a result, the amount of color misregistration between black (K) and another color (cyan (C), magenta (M), or yellow (Y)) due to the speed difference between the fixing speed and the transfer speed is different for each color.

### 3. Operation of Image Forming Apparatus

Next, color misregistration correction processing that is executed before a print job is executed in the image forming apparatus 1 will be described.

The third controller 36 of the image forming apparatus 1 cooperates with the program stored in the storage section 37 to execute the color misregistration correction processing.

The third controller 36 executes the color misregistration correction processing, for example, when the main body 30 receives job information of a print job from an external device or the like via the communication section 38. The external device is, for example, a computer.

The third controller 36 corrects color misregistration in an image formed on a sheet by the image forming section 34 by executing the color misregistration correction processing.

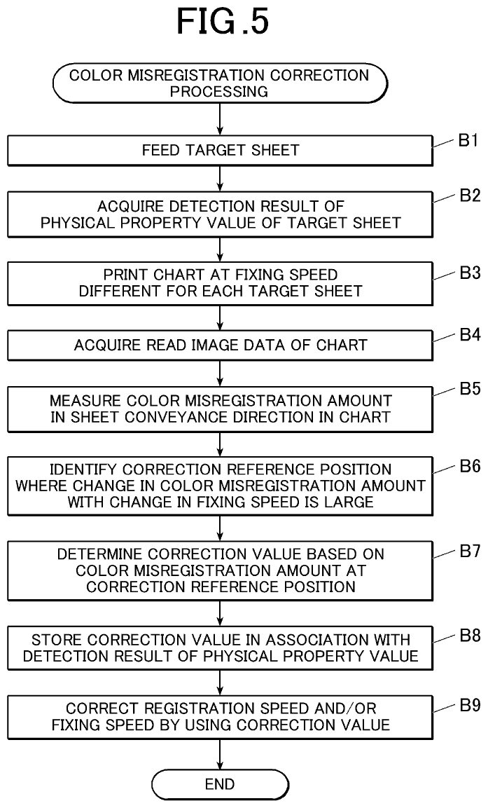

FIG. 5 shows a flowchart of the color misregistration correction processing.

### (Color Misregistration Correction Processing)

The third controller 36 feeds the target sheet of the print job from the sheet feed device 10 based on the received job information (step B1). In the present embodiment, it is assumed that the target sheet of the print job is thick paper.

Next, the third controller 36 causes the detection device 20 to detect the target sheet, thereby acquiring a detection result of a physical property value of the target sheet (step B2).

Next, the third controller 36 controls the image forming section 34 to form a chart at a fixing speed different for each target sheet (step B3). The chart is used to measure a color misregistration amount between at least two colors among yellow (Y), magenta (M), cyan (C), and black (K) in an image formed by the image forming section 34.

In the present embodiment, the different fixing speeds include, but are not limited to, a standard speed, a speed faster than the standard speed, and a speed slower than the standard speed. The different fixing speeds need only include at least a first speed and a second speed that are different from each other.

Next, the third controller 36 causes the image reading device 40 to read the chart formed on the target sheet in step B3 and acquires a read image data that is a reading result (step B4).

Next, the third controller 36 measures the amount of color misregistration between the two colors in the chart in the sheet conveyance direction based on the read image data acquired in step B4 (step B5). The third controller 36 functions as a measurement section.

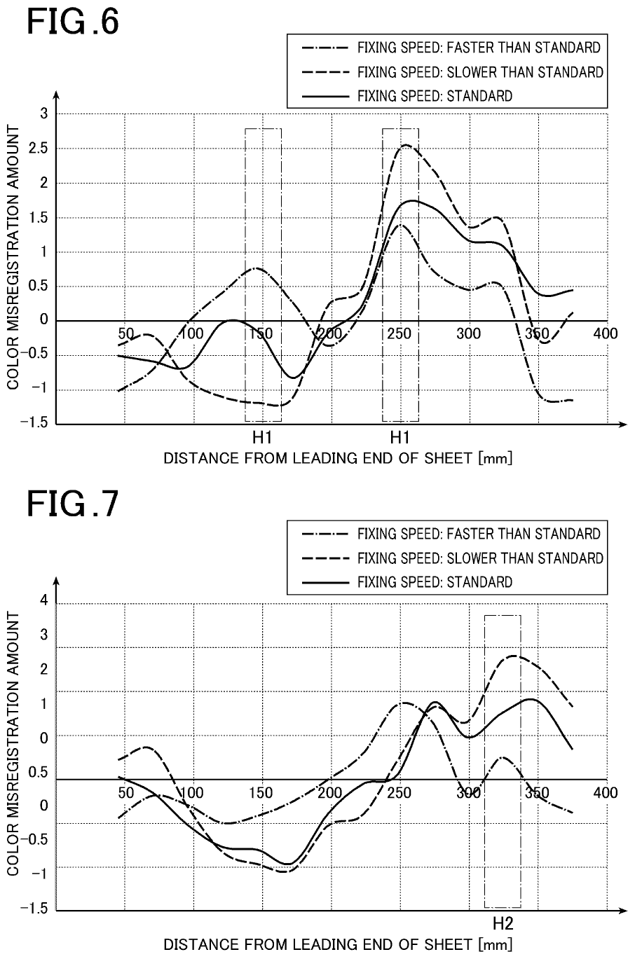

FIG. 6 illustrates a measurement result of the color misregistration amount between black (K) and cyan (C) when the target sheet has the A3 size.

FIG. 7 illustrates a measurement result of the color misregistration amount between black (K) and magenta (M) when the target sheet has the A3 size.

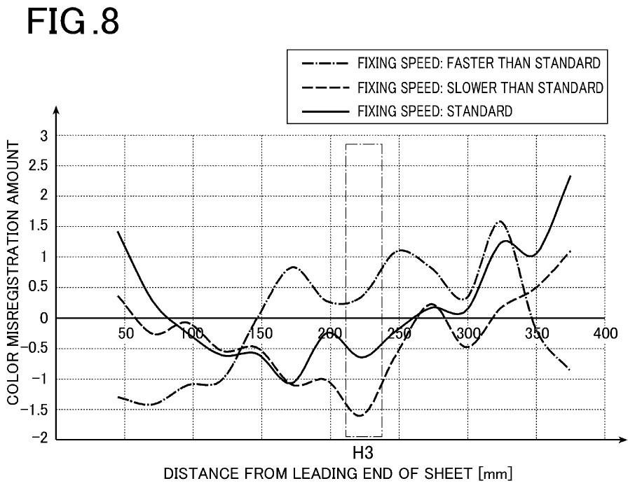

FIG. 8 illustrates a measurement result of the color misregistration amount between black (K) and yellow (Y) when the target sheet has the A3 size.

In FIG. 6 to FIG. 8, the horizontal axis represents the distance [mm] from the leading end of the target sheet, and the vertical axis represents the color misregistration amount between the two colors.

Next, the third controller 36 identifies, in the measurement result of the color misregistration amount measured in step B5, a correction reference position, which is a position in the sheet conveyance direction where the change in the color misregistration amount with a change in the fixing speed is larger than a predetermined threshold value (step B6).

In step B6, the third controller 36 identifies the correction reference position in each of the measurement result of the color misregistration amount between black (K) and cyan (C), the measurement result of the color misregistration amount between black (K) and magenta (M), and the measurement result of the color misregistration amount between black (K) and yellow (Y).

FIG. 6 illustrates the correction reference position H1 in the measurement result of the color misregistration amount between black (K) and cyan (C).

FIG. 7 illustrates the correction reference position H2 in the measurement result of the color misregistration amount between black (K) and magenta (M).

FIG. 8 illustrates the correction reference position H3 in the measurement result of the color misregistration amount between black (K) and yellow (Y).

Next, the third controller 36 determines, based on the color misregistration amounts at the correction reference positions H1 to H3 identified in step B6, correction values for the registration speed and/or the fixing speed in the image formation process of the main body 30 (step B7). The third controller 36 functions as a determination section.

The registration speed is a sheet conveyance speed at the registration section 346.

In step B7, the third controller 36 determines the correction values so that the color misregistration amounts at the correction reference positions H1 to H3 become smaller than those in the measurement results in step B5.

In step B7, the third controller 36 may determine the correction value so that the color misregistration amount at least one of the correction reference positions H1 to H3 becomes smaller than that in the measurement result in step B5.

Next, the third controller 36 stores, in the storage section 37, the correction values determined in step B7 in association with the detection result of the physical property value of the target sheet acquired in step B2 (step B8).

Next, the third controller 36 adjusts and corrects the registration speed and/or the fixing speed according to the correction values determined in step B7 (step B9) and ends the color misregistration correction processing. The third controller 36 functions as a controller.

### 4. Others

The third controller 36 may adjust the registration speed and/or the fixing speed to correct the color misregistration during execution of the print job. In this case, the third controller 36 causes the detection device 20 to detect the target sheet of the print job being executed, thereby acquiring the detection result of the physical property value of the target sheet. Next, the third controller 36 acquires, from the storage section 37, correction values associated with the same physical property value as the physical property value of the target sheet of the print job. Next, the third controller 36 adjusts the registration speed and/or the fixing speed according to the acquired correction values.

During conveyance of the sheet in execution of the print job, the third controller 36 may adjust the registration speed and/or the fixing speed by using the correction values determined in step B7 only at timings corresponding to the correction reference positions H1 to H3 identified in step B6.

The detection section (detector) that detects the physical property value of the target sheet in step B2 of the color misregistration correction processing may be provided in each of the sheet feed trays 131 to 133.

In step B7 of the color misregistration correction processing, the third controller 36 may determine the correction values based on the detection result of the physical property value of the target sheet acquired in step B2 and the color misregistration amounts at the correction reference positions H1 to H3 identified in step B6.

### 5. Effects

As described above, the control device 100 according to the present embodiment includes a measurement section (the third controller 36) that measures, in an image formed on a sheet, the amount of color misregistration in the conveyance direction of the sheet.

The control device 100 according to the present embodiment includes a determination section (third controller 36) that determines correction values for correcting the color misregistration in the conveyance direction of the sheet based on the amounts of color misregistration at respective predetermined positions (the correction reference positions H1 to H3) in the conveyance direction of the sheet measured by the measurement section.

The control device 100 according to the present embodiment includes a controller (the third controller 36) that corrects the color misregistration in an image to be formed on the sheet by using the correction values determined by the determination section.

Therefore, it is possible to perform correction in consideration of the fact that the color misregistration amount due to the sheet conveyance speed variation changes depending on the position in the conveyance direction within the sheet.

Thus, the color misregistration in the image to be formed on the sheet can be corrected with high accuracy.

In the control device 100 according to the present embodiment, the determination section (the third controller 36) determines the correction values so that the color misregistration amounts measured at the respective predetermined positions (the correction reference positions H1 to H3) become smaller.

Therefore, the color misregistration can be effectively corrected by performing correction in such a way that the color misregistration amounts at the correction reference positions H1 to H3 where the change in the color misregistration amount due to the sheet conveyance speed variation is large become small.

In the control device 100 according to the present embodiment, the determination section (the third controller 36) determines the correction values before execution of a print job.

Therefore, it is possible to omit the process of determining the correction values for correcting the color misregistration during the execution of the print job.

The control device 100 according to the present embodiment includes the storage section 37 that stores the correction values determined by the determination section (the third controller 36).

Therefore, the third controller 36 can correct color misregistration by using the correction values stored in the storage section 37.

In the control device 100 according to the present embodiment, the controller (third controller 36) corrects color misregistration between at least two colors in the image to be formed on the sheet.

Therefore, it is possible to accurately correct the color misregistration between at least two colors in the image to be formed on the sheet.

The control device 100 according to the present embodiment includes a reading section (reader, image reading section 42) that reads the image formed on the sheet.

The measurement section (third controller 36) measures, based on a reading result of the image read by the reading section, the amounts of color misregistration in the conveyance direction of the sheet in the image formed on the sheet.

Therefore, the color misregistration amounts in the sheet conveyance direction can be easily measured based on the reading result read by the image reading section 42.

The image forming apparatus 1 according to the present embodiment includes the control device 100 and the image forming section 34 that forms an image in a plurality of colors on the sheet by the intermediate transfer method.

Therefore, it is possible to accurately correct color misregistration in the image formed by the image forming apparatus in which color misregistration in the sheet conveyance direction may occur.

In the image forming apparatus 1 according to the present embodiment, the image forming section 34 includes the registration section 346 that conveys the sheet to the transfer portion 343a in which the image is transferred onto the sheet, and the fixing section 344 that fixes the image onto the sheet.

The controller (third controller 36) adjusts at least one of the conveyance speed at the registration section 346 or the conveyance speed at the fixing section 344 by using the correction values to correct the color misregistration.

Therefore, the color misregistration can be accurately corrected by adjusting the registration speed and/or the fixing speed.

The image forming apparatus 1 according to the present embodiment includes the detection section 22 that detects the attribute information of the sheet.

The determination section (third controller 36) determines a correction value for each piece of attribute information on the sheet detected by the detection section 22.

Therefore, it is possible to perform highly accurate color misregistration correction according to the attribute information of the sheet.

In the image forming apparatus 1 according to the present embodiment, the controller (third controller 36) adjusts at least one of the conveyance speed at the registration section 346 or the conveyance speed at the fixing section 344 to correct the color misregistration at the timings corresponding to the respective predetermined positions (correction reference positions H1 to H3) during the conveyance of the sheet.

Therefore, the color misregistration can be effectively corrected by performing the correction at the timings corresponding to the correction reference positions H1 to H3 where the change in the color misregistration amount due to the sheet conveyance speed variation is large. In the image forming apparatus 1 according to the present embodiment, the sheet is thick paper having a predetermined thickness or more or a predetermined basis weight or more.

Therefore, even when an image is formed on thick paper in which the color misregistration in the sheet feeding direction (sheet conveyance direction) is likely to occur, the color misregistration can be accurately corrected.

Although specific description has been given above based on the embodiment according to the present disclosure, the present disclosure is not limited to the above-described embodiment, and changes can be made without departing from the spirit and scope of the present disclosure.

For example, the image forming apparatus 1 may be capable of transmitting and receiving information for mutual cooperation with a print controller (not illustrated) that performs print job generation, print management, and the like, another image forming system (not illustrated), a business management system, and the like.

In the present embodiment, the third controller 36 of the main body 30 integrally controls the entire image forming apparatus 1, but the present invention is not limited thereto. A control device may be separately provided, and a controller of the control device may integrally control the entire image forming apparatus 1.

In addition, the detailed configuration of each device constituting the image forming apparatus 1 and the detailed operation of each device can also be appropriately modified without departing from the spirit and scope of the present disclosure.

Although embodiments of the present invention have been described and illustrated in detail, the disclosed embodiments are made for purposes of illustration and example only and not limitation. The scope of the present invention should be interpreted by terms of the appended claims.

What is claimed is:

1. A control device comprising a hardware processor that:
measures, in an image formed on a sheet, an amount of a color misregistration in a conveyance direction of the sheet;
determines, based on the measured amount of the color misregistration at a predetermined position in the conveyance direction, a correction value for correcting the color misregistration in the conveyance direction; and
corrects the color misregistration in an image to be formed on the sheet by using the determined correction value.

2. The control device according to claim 1, wherein the hardware processor determines the correction value so that the amount of the color misregistration measured at the predetermined position becomes smaller.

3. The control device according to claim 1, wherein the hardware processor determines the correction value before execution of a print job.

4. The control device according to claim 1, further comprising a storage that stores the correction value determined by the hardware processor.

5. The control device according to claim 1, wherein the hardware processor corrects the color misregistration between at least two colors in the image to be formed on the sheet.

6. The control device according to claim 1, further comprising a reader that reads the image formed on the sheet, wherein, based on a reading result of the image read by the reader, the hardware processor measures the amount of the color misregistration in the conveyance direction in the image formed on the sheet.

7. An image forming apparatus comprising:
the control device according to claim 1; and
an image former that forms an image in a plurality of colors on the sheet by an intermediate transfer method.

8. The image forming apparatus according to claim 7, wherein
the image former includes:
a registration section that conveys the sheet to a transfer portion in which the image is transferred onto the sheet; and
a fixing section that fixes the image onto the sheet, and
the hardware processor adjusts at least one of a conveyance speed at the registration section or a conveyance speed at the fixing section by using the correction value to correct the color misregistration.

9. The image forming apparatus according to claim 7, further comprising a detector that detects attribute information of the sheet, wherein the hardware processor determines the correction value for each piece of the attribute information detected by the detector.

10. The image forming apparatus according to claim 8, wherein the hardware processor adjusts at least one of the conveyance speed at the registration section or the conveyance speed at the fixing section to correct the color misregistration at a timing corresponding to the predetermined position during conveyance of the sheet.

11. The image forming apparatus according to claim 7, wherein the sheet is thick paper having a predetermined thickness or more or a predetermined basis weight or more.

12. A non-transitory computer-readable storage medium storing a program that causes a computer of a control device to:
measure, in an image formed on a sheet, an amount of a color misregistration in a conveyance direction of the sheet;
determine, based on the measured amount of the color misregistration at a predetermined position in the conveyance direction, a correction value for correcting the color misregistration in the conveyance direction; and
correct the color misregistration in an image to be formed on the sheet by using the determined correction value.
